(19) United States
(12) Patent Application Publication
(10) Pub. No.: US 2026/0112069 A1
(43) Pub. Date: Apr. 23, 2026

(54) METHOD AND DEVICE FOR FINE-TUNING A SELECTED SET OF PARAMETERS IN A DEEP CODING SYSTEM

(71) Applicant: InterDigital CE Patent Holdings, SAS, Paris (FR)

(72) Inventors: Francois Schnitzler, Saint Avé (FR); Muhammet Balcilar, Betton (FR); Anne Lambert, Saint-Aubin-d'Aubigné (FR); Oussama Jourairi, Rennes (FR)

(21) Appl. No.: 19/122,337

(22) PCT Filed: Oct. 6, 2023
(86) PCT No.: PCT/EP2023/077711

§ 371 Date: Apr. 18, 2025

(30) Foreign Application Priority Data
Oct. 21, 2022 (EP) 22306599.6

(51) Int. Cl. G06T 9/00; G06N 3/0455; G06N 3/08

(52) U.S. Cl. CPC G06T 9/002; G06N 3/0455; G06N 3/08

(57) ABSTRACT

A deep neural network-based coding system for images determines update parameters of a deep neural network model for decoding an image. These parameters are determined by an encoder and provided to a decoder to update the model of the decoder before decoding the image. This provides structural sparsity by fine-tuning only some parameters of the neural decoder. The update is done on a set of parameters selected based on the embedding representative of the coded image so that there is no need to transmit information related to the selection of the parameters to be updated. A more generic optimizer/inference engine is also described as well as an application to sound upsampling.

This application claims the priority to European Application N° 22306599.6 filed 21 Oct. 2022, which is incorporated herein by reference in its entirety.

### TECHNICAL FIELD

At least one of the present embodiments generally relates to neural networks and more particularly to fine-tuning a selected set of parameters of a deep neural network.

### BACKGROUND

A deep neural network is composed of multiple neural layers such as convolutional layers. Each neural layer can be described as a function that first multiplies the input by a tensor, adds a vector called the bias and then applies a nonlinear function on the resulting values. The shape (and other characteristics) of the tensor and the type of non-linear functions are called the “architecture” of the network. The values of the tensor and the bias are hereafter called “weights”. The weights and, if applicable, the parameters of the non-linear functions, are called “parameters”. The architecture and the parameters define a “model”.

A model M can be trained on a database D of images to learn its weights. In supervised learning, this database comprises input/output pairs (i, o) and the model M is a function that tries to predict an output from the input: M_{θ}(i)=ô. The weights are optimized to minimize a training loss, such as L_{T}(M,D)=E_{i˜D} [d(o, ô)], where d measures a difference between the real output and the predicted output. As an example, d can be the square error or the Euclidian distance. The loss function can also contain additional terms, such as regularization terms. The values of the parameters are hereafter denoted by θ. Using the trained model is called inference.

Training is successful when the resulting value of the loss is small. The trained model performs well on average for all inputs, but it is likely to be suboptimal for any single input. In some applications, such as compression, inference is part of a two-step systems where an input is first prepared or viewed by an optimizer (the encoder in compression) and in a second step, often in another device, processed by an inference engine (within the decoder in compression). In such a system, it is possible to improve an inference result by fine-tuning (in other words by retraining) the weights of the model individually for each input in the optimizer. By retraining M specifically for this input, transmitting weight updates δ to the inference engine in addition to the input, and adding δ to θ before inference, the reconstructed output M_{θ+δ}(i)=ô(δ) better matches the desired result. The retraining loss used for fine-tuning can be:

L_{FT}(M,δ,o)=d(o,ô(δ))

Image and video compression is a fundamental task in image processing, which has become crucial in the time of pandemic and increasing video streaming. Thanks to the community's huge efforts for decades, traditional methods have reached current state of the art rate/distortion performance and dominate current industrial codecs solutions. End-to-end trainable deep models have recently emerged as an alternative, with promising results. They now beat the best traditional compressing method (VVC, versatile video coding) even in terms of peak signal-to-noise ratio for single image compression.

### SUMMARY

In at least one embodiment, a deep neural network-based coding system for images determines update parameters of a deep neural network model for decoding an image. These parameters are determined by an encoder and provided to a decoder to update the model of the decoder before decoding the image. This provides structural sparsity by fine-tuning only some parameters of the neural decoder. The update is done on a set of parameters selected based on the embedding representative of the coded image so that there is no need to transmit information related to the selection of the parameters to be updated. A more generic optimizer/inference engine enabling data transformation is also described as well as an application to sound upsampling.

According to a first aspect, a method comprises obtaining input data, selecting a subset of parameters for fine-tuning a model of a neural network, determining parameters updates for the selected subset of parameters based on a loss function, and packaging input data and parameters update.

According to a second aspect, a method comprising obtaining input data and parameters update for a selected subset of parameters, selecting a subset of parameters for fine-tuning a model of a neural network-based on a parameter optimization and the input data, updating the model of a neural network-based on parameters update for the selected subset of parameters; and determining output data by processing the input data with the updated neural network.

According to a third aspect, a device comprises a processor configured to obtain input data, select a subset of parameters for fine-tuning a model of a neural network, determine parameters updates for the selected subset of parameters based on a loss function, and package input data and parameters update.

According to a fourth aspect, a device comprises a processor configured to obtain input data and parameters update for a selected subset of parameters, select a subset of parameters for fine-tuning a model of a neural network-based on a parameter optimization and the input data, update the model of a neural network-based on parameters update for the selected subset of parameters and determine output data by processing the input data with the updated neural network.

In a first variant of first and third aspect adapted for encoding an image, the input data is an image, a first neural network is used for encoding and a second neural network is used for decoding, the second neural network being updated using parameters updates for the selected subset of parameters, the method further comprises determining an embedding representative of the input by encoding the image using the first neural network, quantizing the embedding; and performing the selection of subset of parameters based on the quantized embedding.

In a second variant of first and third aspect adapted for compressing sound, the input data is an audio signal, the method further comprises compressing the audio signal, decompressing the compressed audio signal, performing the selection of subset of parameters based on the decompressed compressed audio signal; and packaging the compressed audio signal and parameters update.

In a first variant of second and fourth aspect adapted for decoding an image, the selection of subset of parameters is further based on an obtained quantized embedding.

In a second variant of second and fourth aspect adapted for decoding sound, the selection of subset of parameters is further based on an obtained decompressed audio signal.

According to a fifth aspect of at least one embodiment, a computer program comprising program code instructions executable by a processor is presented, the computer program implementing the steps of a method according to at least the first or second aspect when executed on a processor.

According to a sixth aspect of at least one embodiment, a non-transitory computer readable medium comprising program code instructions executable by a processor is presented, the instructions implementing the steps of a method according to at least the first or second aspect when executed on a processor.

In variants of first, second, third and fourth embodiments, the parameters are selected among a set comprising a bias, a weight, parameters of a non-linear function of the model, a subset of layers of the model, a specific layer of the model, the bias of a specific layer of the model, and a subset of neurons of the model.

### BRIEF DESCRIPTION OF THE DRAWINGS

FIG. 1 illustrates an example of end-to-end neural network-based compression system for encoding an image using a deep neural network.

FIG. 2 illustrates the process for an optimizer according to at least one embodiment for a generic data transformation system.

FIG. 3 illustrates the process for an inference engine according to at least one embodiment for a generic data transformation system.

FIG. 4 illustrates an architecture diagram for an optimizer and an inference engine according to at least one embodiment.

FIG. 5A illustrates the process for an encoder in a context of an end-to-end image compression system according to at least one embodiment.

FIG. 5B illustrates the process for a decoder in a context of an end-to-end image compression system according to at least one embodiment.

FIG. 6 illustrates an architecture of an encoder in a context of an end-to-end image compression system according to at least one embodiment.

FIG. 7 illustrates an architecture of a decoder in a context of an end-to-end image compression system according to at least one embodiment.

FIG. 8 illustrates an example of size information for a bitstream generated according to at least one embodiment compared to a bitstream for an identical input generated without any of the presented embodiments.

FIG. 9 illustrates an example of the application of an optimizer and an inference engine to the context of sound enhancement according to at least one embodiment.

FIG. 10 illustrates a block diagram of an example of a system in which various aspects and embodiments are implemented.

FIG. 11 illustrates the process for an image encoder according to at least one embodiment.

FIG. 12 illustrates the process for an image decoder according to at least one embodiment.

### DETAILED DESCRIPTION

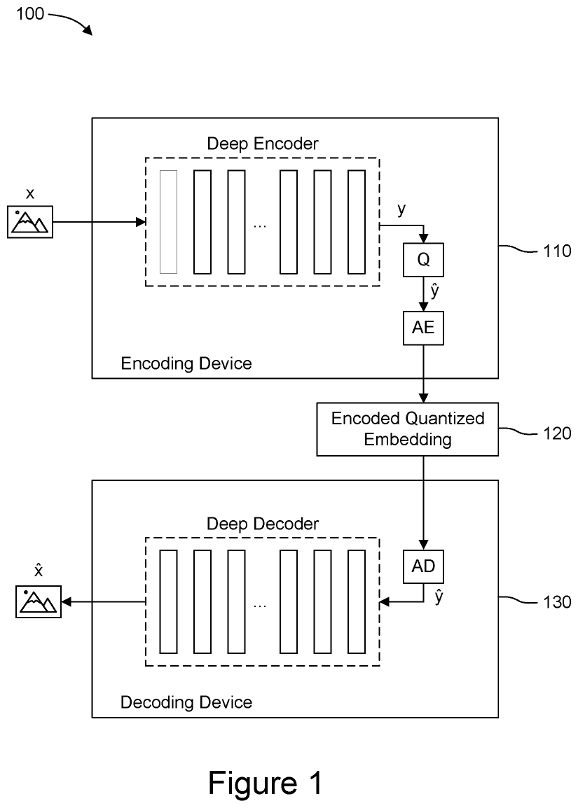

FIG. 1 illustrates an example of end-to-end neural network-based compression system 100 for encoding an image using a deep neural network. An input image to be compressed, x, is first processed by a device 110 comprising a deep neural network encoder (hereafter identified as deep encoder or encoder). The output of the encoder, y, is called the embedding of the image. This embedding is converted into a bitstream 120 by going through a quantizer Q, and then through an arithmetic encoder AE. The resulting bitstream thus comprises an encoded quantized embedding for the input image. This bitstream is provided to a device 130 comprising a deep neural network decoder 130 (hereafter identified as deep decoder or decoder). The bitstream is decoded by going through an arithmetic decoder AD to reconstruct the quantized embedding y. The reconstructed quantized embedding can be processed by the deep decoder to obtain the decompressed image, \hat{x}.

The deep encoder and decoder are composed of multiple neural layers. Typically, the encoder and decoder are fixed, based on a predetermined model supposed to be known when encoding and decoding. The encoder and the decoder models are for example trained simultaneously so that they are compatible. Together, they are sometimes called an “autoencoder”, a model that encodes an input and then reconstructs it. The architecture of the decoder is typically mostly the reverse of the encoder, although some layers or their ordering can be slightly different. The set of parameters of the decoder are hereafter denoted by Ω.

Many end-to-end architectures have been proposed. They may be more complex than the one illustrated in FIG. 1, but they retain the deep encoder and decoder. State of the art models can compete with traditional video codecs such as Versatile Video Coding (VVC) in terms of rate/distortion tradeoffs.

A model M must be trained on massive databases D of images to learn the weights of the encoder and decoder. Typically, the weights are optimized to minimize a rate/distortion training loss, for example expressed as:

$${L}_{T} ( M , D ) = {E}_{x \sim D} [ - log ( {p}_{M} ( \hat{y} ) ) + λ d ( x , \hat{x} ) ] ,$$

where p_{M} denotes the probability of the quantized embedding according to M (thus this term is the theoretical lower bound on bitstream size for the encoded quantized embeddings), d(x, \hat{x}) a measure of the distortion between the original and the reconstructed image (for example the mean square error, Multi-Scale Structural Similarity Index Measure (MS-SSIM), Information Weighted Structural Similarity Index Measure (IWSSIM), Video Multimethod Assessment Fusion (VMAF), Visual Information Fidelity (VIF), Peak Signal to Noise Ratio Human Visual System Modified (PSNR-HVS-M), Normalized Laplacian Pyramid Distance (NLPD) or Feature Similarity Index Measure (FSIM)) and λ a parameter controlling the trade-off between the rate (r) and distortion (d) terms.

Typically, an architecture is trained several times, using different values for λ, to yield a set of models {Mᵢ} with different rate/distortion (r/d) trade-offs. Usually, different architectures yield models with different r/d points. To compare these architectures, the r/d points of each architecture are interpolated, resulting in a function d(r) for each architecture that provides a distortion estimate for any rate value.

The deep decoder as proposed in FIG. 1 can decode any type of image. In other words, it performs well on average for all images, but it is likely to be suboptimal for any single image. It is possible to improve the rate/distortion trade-off for a single video by retraining the decoder specifically for this video and by transmitting weight updates δ for the decoder in addition to the quantized embeddings for intra frames of the video. Before decoding the quantized embedding, δ is added to θ. Such technique is denoted as fine-tuning. The weight updates δ are determined by a fine-tuning algorithm that minimizes a loss function that can for example be:

$${L}_{F T} ( M , δ , x ) = - log ( {p}_{Δ} ( δ ) ) + β d ( x , \hat{x} ( δ ) ) ,$$

where p_{Δ}(·) denotes a probability density over weight updates, \hat{x}(δ) the image reconstructed by the decoder whose weights have been updated by δ and β a trade-off between the two losses.

However, this approach does not achieve rate/distortion improvements for single images because of the increased code size due to the inclusion of the weight updates. In an example solution, an additional term may be added to the loss to enforce a global sparsity constraint on δ, so that a lot of weight updates have the same value (0), to make encoding more efficient.

The current approach of fine-tuning the decoder with a global sparsity constraint leads to an improved performance in terms of rate/distortion for encoding a video. However, this approach is not suitable for single images because of the increased code size due to the inclusion of the weight updates, even with the global sparsity constraint.

A second solution proposes to fine-tune the decoder for single images by updating either a fixed subset of weights for all images or a subset of weights specific for each image. In the latter case, the weights updated must be identified in the bitstream.

Previous approaches for instance specific weight overfitting necessarily suffer from one suboptimality problem. When the same subset of weights is optimized for every input, the selection of weights is not optimal for every input. When the subset of weights is selected specifically for each input, those weights must be identified in the bitstream, therefore increasing the bit length. To limit this extra cost, weights are typically selected in chunks, for example layer by layer, thus also limiting the reduction in distortion.

Embodiments described hereafter have been designed with the foregoing in mind and are based on a new fine-tuning procedure that proposes to select implicitly the subset of weights that are optimized for a particular input, using a procedure that the inference engine can reproduce. In other words, embodiments are based on selecting and optimizing an input-specific subset of weights without requiring the transmission of the identifier (or location) of these weights. Therefore, this selection of weight is better suited to a particular input (such as an image or frame, a GoP, a patch, or other inputs), but does not increase the bit length since the position of the selected weights does not need to be transmitted. The updates still need to be transmitted. The trade-off is an increased computing cost in the inference engine.

One embodiment relates to a generic data transformation system comprising fine-tuning capabilities. In an embodiment for end-to-end compression, the inference engine is an end-to-end decoder. In at least an embodiment, the principle is applied to a video compression system comprising a video encoder and a video decoder and allows to reduce the size of the encoded video bitstream generated by the encoder since it does not comprise any information identifying the weights to be updated.

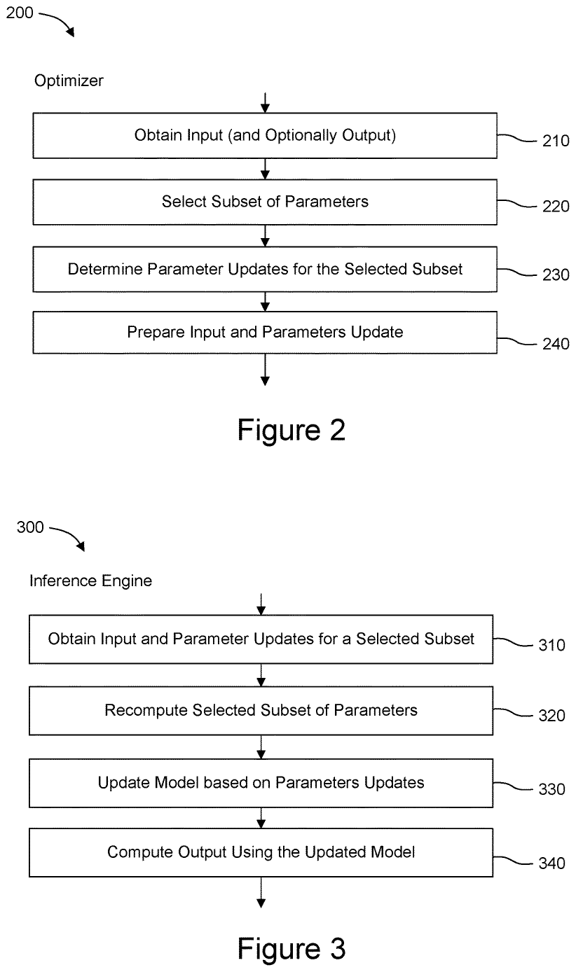

A generic system for data transformation based on selecting and optimizing an input specific subset of weights without transmitting the identifier of these weights can be implemented through an optimizer and an inference engine is illustrated in FIGS. 2 and 3 according to at least one embodiment.

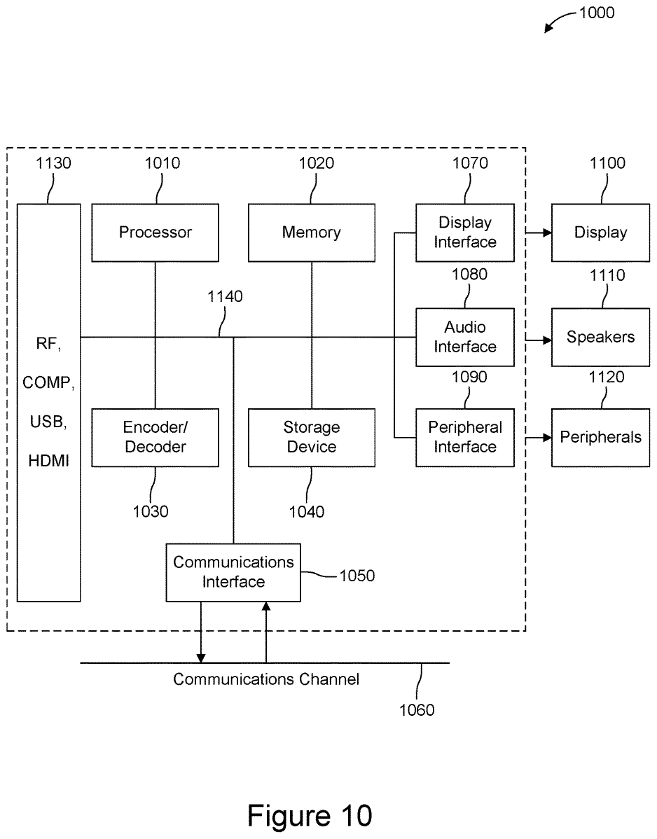

FIG. 2 illustrates the process 200 for an optimizer according to at least one embodiment for a generic data transformation system. This optimizer contains a model M which is identical to the model of the inference engine. This model implements any function mapping an input domain to an output domain. The process 200 is for example implemented by a device 1000 of FIG. 10 and more particularly by a processor 1010 of such device. In step 210, the optimizer obtains data representative of an input i and optionally data representative of a target output o, that is the desired output for the inference engine. If the target output is present, this output is the goal for the model M and the optimizer will try to optimize the parameters of the model so that the output is closer to that target output. If the target output is not present, the optimizer may try to optimize a metric over the output that does not take a target into account. These will be called “reference-less” metrics. For example, if the output domain of the model is images, it may use a metric such as BRISQUE (Blind/Reference-less Image Spatial Quality Evaluator), if the domain is related to probability distributions over label, it may try to maximize the probability of a label or if the output domain is audio signals, optimization could attempt to limit clipping or Gaussianity of the signal.

In step 220, the optimizer selects a subset of weights ω*⊂Ω of a fixed size s, based on the input i:

$${ω}^{*} = f ( M , i ) .$$

This computation will be reproduced by the inference engine. Therefore, this step does not depend on the target output (as the inference engine does not have access to it), but only relies on the quantized embedding.

An ideal selection could be the solution to the following optimization problem:

$${ω}^{*} = arg {min}_{{ω ⊂ Ω}_{\vert ω \vert = s}} {L}_{T} ( M , {δ}_{ω} , o ) ,$$

where δ_{ω} denotes the updates corresponding to the parameters ω. However, as it depends on the target output o, the above problem formulation cannot be used by the inference engine, so in at least one embodiment, it is proposed to replace it with another approach. Hereafter, three different approaches to select the subset ω* are described.

The idea of the first approach is to select the weights that, when modified, have the largest impact on the target output of the model M. This property can be estimated through the gradient of the target output of the model. This can be easily computed by using the backpropagation algorithm (typically used for training the model). Hence, in this first approach the subset of weights is computed as follows:

$${ω}^{*} = ( {Ω}_{{j}^{′}} ‖ {∇}_{{j}^{′}} M ( i ) \vert \geq \vert {∇}_{j} M ( i ) \vert ∀ j ∉ {ω}^{*} )$$

$$\vert {ω}^{*} \vert = s$$

where ∇ denotes the gradient with respect to the parameters Ω.

A second approach proposes to use machine learning algorithms to directly infer the subset from the input. A possible choice is to use a supervised learning algorithm. In that case, a second machine learning model N is trained using a database containing pairs of input i and optimal subset ω*(i) for this input. This second element, ω*(i), is the output of the model N. Such a model N can then be used as a function ƒ(M,i) in the inference engine to determine the subset of parameters to be updated based on the quantized embedding. This function can be known by both the encoder and decoder, so that the location/identifier of the updated weights does not need to be transmitted.

A third approach is to use a reinforcement learning algorithm. Such algorithm could for example gradually construct ω* by adding or removing elements of Ω, fine-tuning updates for these weights and using the resulting r/d tradeoff as a reward for the algorithm.

Many variants of these approaches are envisioned. In a first variant, the optimization is performed over a subset Ω′⊂Ω rather than Ω. For example, this limited subset may consist of the bias and/or the weights and/or the parameters of the non-linear functions and/or any subset of these elements. Such a subset may for example be defined as a subset of the layers, such as the last k layers, or the bias of the last k layers, or a subset of the neurons.

In a second variant, additional constraints are imposed on admissible values of ω. For example, Ω (or Ω′) might be divided into non-overlapping subsets Ω₁, . . . , Ωₘ⊂Ω and the search might be limited to subsets w such that, for any pair (ωᵢ, ωⱼ) of different elements of ω, ωᵢ, ωⱼ do not belong to the same subset Ωₗ. Alternatively, the constraint could be that at most m elements of ω belong to any subset Ωₗ. One motivation for this approach is to spread the impact of the updates over the whole model.

The weight selection could be performed using a reference-less loss. In that case, the optimization might be done to maximize a function that quantifies the quality of the output of M(i). As an example, a BRISQUE metric can be used to evaluate the quality of an image. Other reference-less losses were also discussed above.

In embodiments, this procedure is not limited to deep neural network but may use any machine learning model.

In step 230, a fine-tuning algorithm computes updates δ_{ω*} corresponding to the parameters ω*. The fine-tuning loss is for example:

$${L}_{F T} ( M , {δ}_{{ω}^{*}} , 0 ) = d ( o , \hat{o} ( {δ}_{{ω}^{*}} ) )$$

This loss might be the same or different than the loss used in the second step. The loss may also contain additional terms, for example a term inducing some constraint on the weights such as a sparsity constraint. In a variant of this embodiment, the input i can be fine-tuned jointly with δ_{ω*}.

If no output is provided, the updates may be computed by optimizing any loss that does not require a reference signal, such as the reference-less losses described above.

In step 240, the input and weight updates are prepared for the inference engine, for example packaged as a set of data stored together.

FIG. 3 illustrates the process for an inference engine according to at least one embodiment for a generic data transformation system. The process 300 is for example implemented by a device 1000 of FIG. 10 and more particularly by a processor 1010 or a decoder 1030 of such device. In step 310, the device obtains one input and the associated parameter updates for a selected subset of parameters. In step 320, the subset selection of parameters is recomputed from the input and the model M, using the same procedure as in the optimizer (or a procedure giving the same result). In step 330, the model M is updated based on the recomputed subset of parameters and the parameters updates. In step 340, the updated model M processes the input and determines the output.

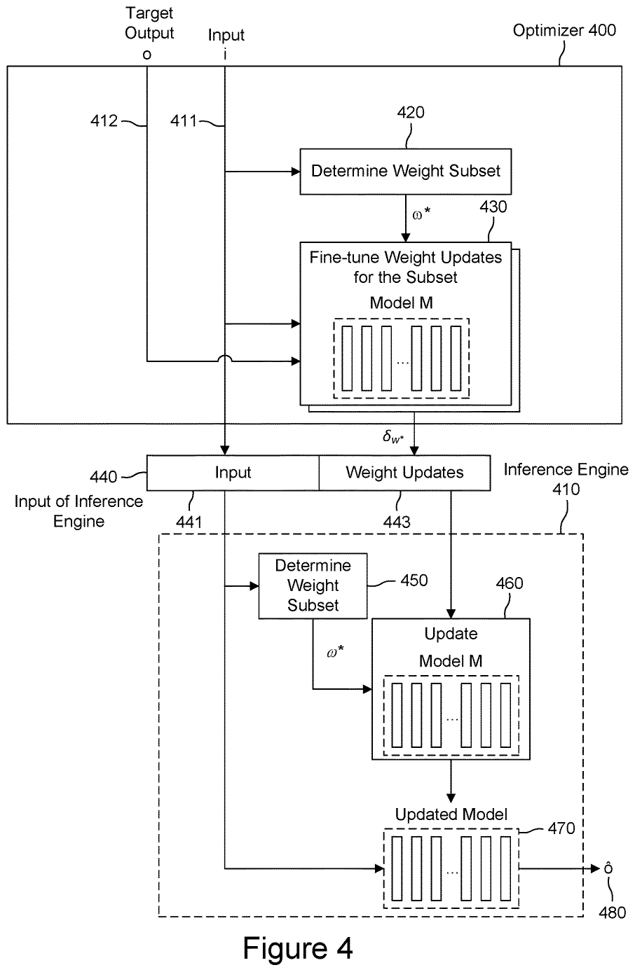

In at least one embodiment, an example of parameter used in the process 200 of FIG. 2 and the process 300 of FIG. 3 is the weight, as illustrated in FIG. 4.

FIG. 4 illustrates an architecture diagram for an optimizer and an inference engine according to at least one embodiment. The optimizer (400) obtains an input i (411) and optionally a target output o (412). In step 420, the optimizer selects a subset of weights ω*⊂Ω of a fixed size s, based on the input i. In step 430, a fine-tuning algorithm computes updates δ_{ω*} corresponding to the parameters ω*. Finally, the input and weight updates are stored together and/or prepared for the inference engine (410). The inference engine obtains data (440) comprising the input (441) and the associated weight updates (443). In step 450, the subset of weights ω* is recomputed from the input and the model M, using the same procedure as in the optimizer (or a procedure giving the same result). In step 460, the model M is updated based on the recomputed subset of weights and the weight updates. In step 470, the updated model M processes the input to compute the output ô (480).

The description and drawings mention updating weights for the sake of readability. However, any other parameter of the neural network could be updated using the same technique. In other words, the embodiments described below as applying to weights also apply more generally to any parameters of a neural network model, namely the parameters selected among a set comprising a bias, a weight, parameters of a non-linear function of the model, a subset of layers of the model, a specific layer of the model, the bias of a specific layer of the model, and a subset of neurons of the model.

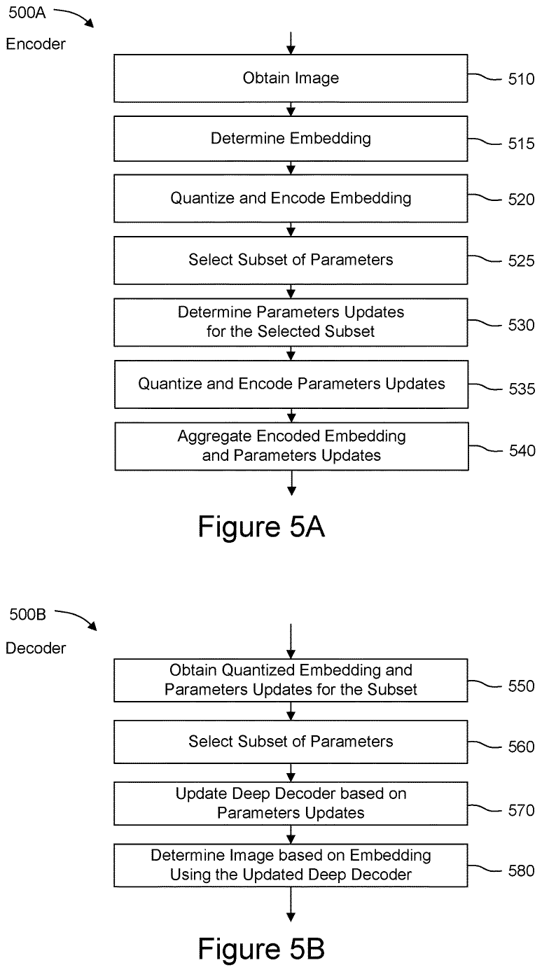

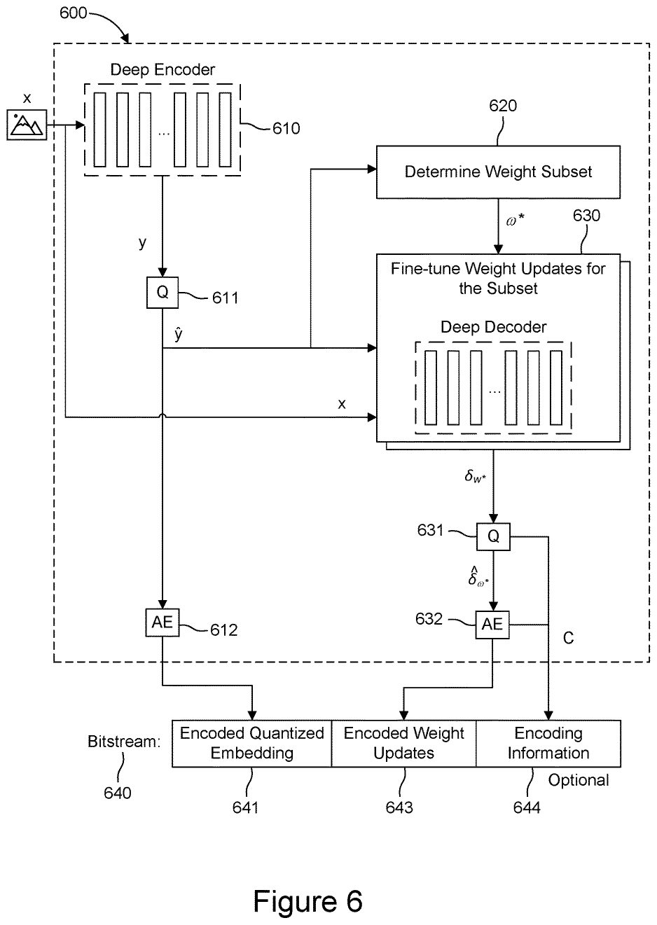

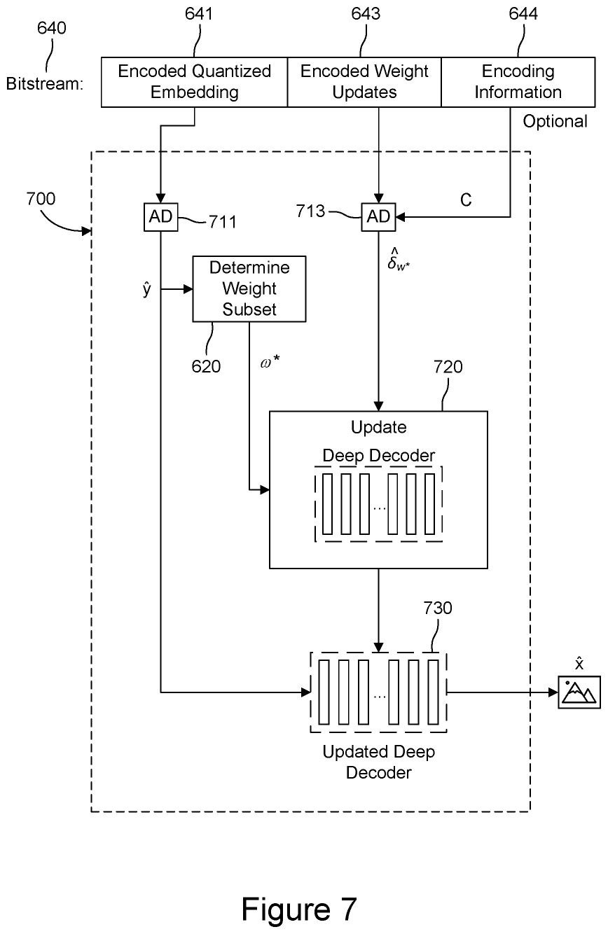

According to at least one embodiment, the generic data transformation system based on selecting and optimizing an input specific subset of weights without transmitting the identifier of these weights (as described in FIGS. 2, 3, 4) is applied to an image compression system and implemented through an image encoder and an image decoder. Processes for these devices are respectively illustrated in FIGS. 5A and 5B. Architectures for these devices are respectively illustrated in FIGS. 6 and 7. In this context of end-to-end compression, the inference engine is the decoder, the optimizer is the encoder, and the weight selection procedure is done both in the encoder and decoder. The output o and input i of the general approach are here respectively an image/frame x to be encoded and the corresponding quantized embedding vector ŷ. The image encoder and decoder may be used as basic components of a video compression system.

FIG. 5A illustrates the process for an encoder in a context of an end-to-end image compression system according to at least one embodiment. The process 500A is for example implemented by a device 1000 of FIG. 10 and more particularly by a processor 1010 or an encoder 1030 of such device. FIG. 6 illustrates an example of architecture of such encoder 600. This encoder is based on the same principles than the optimizer 400 of FIG. 4 but adapted to the context of end-to-end image compression.

In step 510, the encoder obtains an image x. In step 515, the encoder determines the embedding vector y by using a deep encoder (610). In step 520, the embedding vector y is quantized using the quantizer (611). In step 525, the encoder selects a subset of weights ω* of a fixed size s, based on the quantized embedding vector ŷ:

$${ω}^{*} = f ( M , \hat{y} ) .$$

This corresponds to step 220 of the general method described above in FIG. 2. This selection is done by the selection element 620 that is also present in the decoder to allow the decoder to perform the same operation. In the first approach proposed above, namely when selecting parameters that have a large influence on the output on the decoder, the subset of weights could for example be computed as follows:

$${ω}^{*} = ( {Ω}_{{j}^{′}} ‖ {∇}_{{j}^{′}} {M}_{dec} ( \hat{y} ) \vert \geq \vert {∇}_{j} {M}_{dec} ( \hat{y} ) \vert ∀ j ∉ {ω}^{*} )$$

$$\vert {ω}^{*} \vert = s$$

where ∇ denotes the gradient and M_{dec} the decoder part of the deep neural network.

The second approach (using a machine learning model N) is similar to what was described above. The loss to train these models could however take into account the bitlength of the parameter updates in addition to the improvement in the model prediction. In other words, these models would be trained to produce the subset of weights that would achieve the best r/d tradeoff rather than distortion alone.

In step 530 (in relation with element 630 of the architecture), a fine-tuning algorithm computes updates δ_{ω*} corresponding to the parameters ω*. For end-to-end encoding, the fine-tuning loss may be:

$${L}_{F T} ( M , {δ}_{{ω}^{*}} , x ) = - log ( {p}_{Δ} ( {δ}_{{ω}^{*}} ) ) + β d ( x , \hat{x} ( {δ}_{{ω}^{*}} ) ) .$$

The loss may also contain additional terms, for example a term inducing some additional constraint on the weights such as a sparsity constraint.

In a variant of this embodiment, the quantized embedding ŷ can be fine-tuned jointly with δ_{ω*}. In that case, another loss is used, for example:

$${L}_{F T} ( M , {δ}_{{ω}^{*}} , x ) = - log ( {p}_{Δ} ( {δ}_{{ω}^{*}} ) ) - log ( {p}_{M} ( \hat{y} ) ) + β d ( x , \hat{x} ( {δ}_{{ω}^{*}} ) ) .$$

In step 535, these weight updates are typically quantized (631) and encoded (632). These quantized weight updates are denoted by \hat{δ}_{ω*}.

The bitstream (640) is generated, in step 540, for example by aggregating the following data:
the quantized embedding ŷ, for example encoded by an arithmetic encoder (612) or another encoder, thus generating the encoded quantized embedding (641), and
the (quantized) weight updates \hat{δ}_{ω*}, for example encoded by an arithmetic encoder (632) or another encoder, thus generating the encoded quantized weight updates (643).

Optionally, the quantization and encoding of the weight updates may depend on some parameters. These parameters might either be the same for all images or some of them or all of them could be fine-tuned for each image. In the latter case, the bitstream also includes the values of these parameters (denoted by C), inserted as encoding information (644).

The quantization and encoding of the embeddings might also depend on additional parameters. These elements may be arranged in any order or even interleaved in the bitstream.

FIG. 5B illustrates the process for a decoder in a context of an end-to-end image compression system according to at least one embodiment. The process 500B is for example implemented by a device 1000 of FIG. 10 and more particularly by a processor 1010 or a decoder 1030 of such device. FIG. 7 illustrates an architecture of such decoder 700. This decoder is based on the same principles than the inference engine 410 of FIG. 4 but adapted to the context of end-to-end image compression.

In step 550, the quantized embedding and weight updates are extracted from the bitstream (640). Both the quantized embedding and the quantized weight updates are decoded (711 and 713), optionally using parameters carried by the encoding information also extracted from the bitstream.

In step 560, the subset of weights ω* is determined (620) from the quantized embedding. This step must produce the same results as the corresponding step 540 of the encoder. This can be achieved by using the same procedure (620). An advantage of embodiments described herein is that the subset ω* does not need to be included in the bitstream, at the cost of an extra computation (620) in the decoder to perform the selection.

In step 570, the deep decoder is updated (720) based on the subset of weights and the quantized weight updates. In step 580, the image is then decoded from the quantized embedding by the updated decoder (730).

The embodiment described above is based on a system where invertible operations related to quantization of the weight updates are also inverted in the AD block. The same system could be described using an additional block called for example “dequantization” or “inverse quantization” to perform these operations. An example of such an invertible operation is the scaling of the weight updates prior to quantization, to change the quantization resolution.

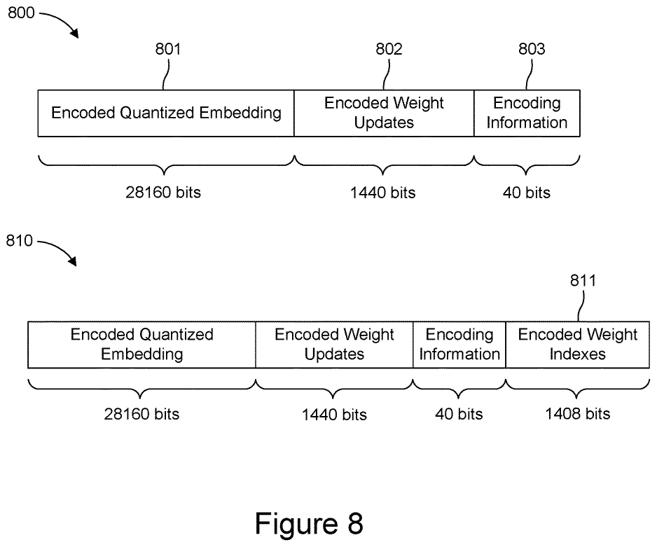

FIG. 8 illustrates an example of size information for a bitstream generated according to at least one embodiment compared to a bitstream for an identical input generated without any of the presented embodiments. The bitstream 800 is generated based on the embodiment related to end-to-end image compression according to an example implementation of the process 500A of FIG. 5A. It comprises an encoded quantized embedding 801, encoded weight updates 802 and optional encoding information 803. The size of these different elements is respectively 28160, 1440 and 40 bits. These particular numbers were obtained when using as the model M the “cheng2020_anchor” end-to-end encoder of the compressAI library. The bitstream 810 is generated based on a state-of-the-art fine-tuning capable end to end neural network-based compression system, based on the same input and with the same settings. Contrary to the proposed embodiment, such system needs to convey information 811 identifying the weights to be updated (i.e., their location based on an index for example) from the encoder to the decoder. Although the other elements of bitstream 810 have the same size as in bitstream 800, the additional data 811 increases the size of the encoded message. Another implementation would lead to other sizes of data but would still provide the same advantage: reducing the size of the generated bitstream and thus increasing the performance of the end-to-end image compression system.

According to at least one embodiment, the generic data transformation system based on selecting and optimizing an input specific subset of weights without transmitting the identifier of these weights (as described in FIGS. 2, 3, 4) is applied to a sound enhancement or compression system.

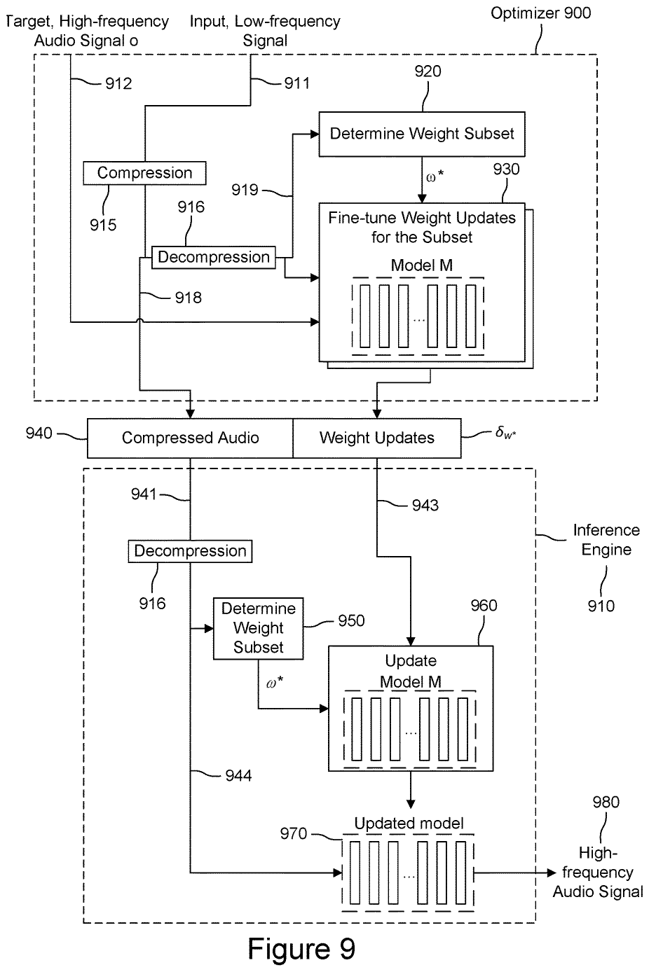

FIG. 9 illustrates an example of the application of an optimizer (900) and an inference engine (901) to the context of sound enhancement according to at least one embodiment. Deep sound upsampling is a sound improvement method where an audio signal is transformed by an upsampling neural network that increases the number of sample points. One possible use of sound upsampling is to improve the quality of a low frequency or downsampled audio signal. In this context, the method can be applied as follows to improve the audio quality of a downsampled audio signal sent to a device. The downsampled original audio signal (or rather, the audio that would be received by the inference engine) is the input i (911). The original, high-frequency audio signal is the target output o (912). The upsampling neural network is the model M.

The original audio signal may be preprocessed by an optimizer before being sent to an audio playback device such as a mobile device or a computer device reading an audio file streamed by a server or any other device adapted for playing audio. In such scenario, the optimizer would be implemented in the audio server and the inference engine in the audio play back device.

The server first obtains the audio file along with the high-frequency target signal. The server then prepares the original audio file for transmission (if not already done), for example by compressing it (915) to obtain signal 918, and processing it, for example decoding or decompressing (916) to recover the signal 919 that is to be used by the inference engine. As an example, it could mean encoding (i.e., compressing) and decoding (i.e., decompressing) the signal. This modified signal (919) is then used to select the subset of weights of the model M to be modified (920). The weight updates δ_{ω*} are then optimized or fine-tuned (930), prepared to be sent to the inference engine and concatenated with the audio files ready for transmission (940). Both are sent to the device with the inference engine or stored for later use.

On the audio playback device, the audio signal (941) and weight updates (943) are received and recovered by an inference engine. This includes any processing (916) that was done in the inference engine (for example decoding or decompressing). The recovered audio signal (944) is then used to determine a subset of weights (950) and this subset, together with the weight updates, is used (960) to update the model M into the update model M′. In other words, the selection of the subset of parameters is independent from information (940) representative of the parameters update. Finally, the received audio signal (944) is used as input for the updated model M′ (970) and the resulting upsampled audio signal (980) is generated. This audio signal can be played to the user or used for any other purpose.

The optimizer 900 and inference engine 901 are for example implemented by a device 1000 of FIG. 10 and more particularly by a processor 1010 or a decoder 1030 of such device. The optimizer 900 and inference engine 901 are respectively based on the same principles than the optimizer 400 of FIG. 4 and the inference engine 410 of FIG. 4 but adapted to the context of end-to-end image compression.

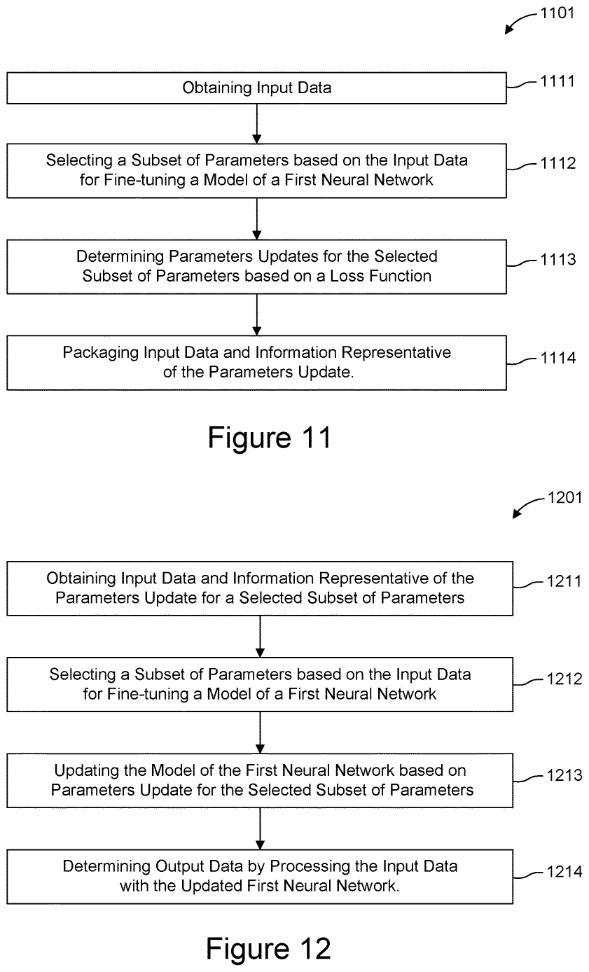

FIG. 10 illustrates a block diagram of an example of a system in which various aspects and embodiments are implemented. System 1000 can be embodied as a device including the various components described below and is configured to perform one or more of the aspects described in this application such as the optimizer 400 of FIG. 4, or the inference engine 410 of FIG. 4, or the encoder 600 of FIG. 6, or the decoder 700 of FIG. 7, or the optimizer 900 of FIG. 9 or the inference engine of FIG. 9. Such system may implement the optimizer process 200 of FIG. 2, or the inference process 300 of FIG. 3, or the encoding process 500A of FIG. 5A, or the decoding process 500B of FIG. 5B, or the encoding process 1101 of FIG. 11 or the decoding process 1201 of FIG. 12. Examples of such devices include, but are not limited to, various electronic devices such as personal computers, laptop computers, smartphones, tablet computers, digital multimedia set top boxes, digital television receivers, personal video recording systems, connected home appliances, encoders, transcoders, and servers. Elements of system 1000, singly or in combination, can be embodied in a single integrated circuit, multiple ICs, and/or discrete components. For example, in at least one embodiment, the processing and encoder/decoder elements of system 1000 are distributed across multiple ICs and/or discrete components. In various embodiments, the system 1000 is communicatively coupled to other similar systems, or to other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, EEPROM, ROM, PROM, RAM, DRAM, SRAM, flash, magnetic disk drive, and/or optical disk drive. The storage device 1040 can include an internal storage device, an attached storage device, and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video, or portions of the decoded video, the bitstream, matrices, variables, and intermediate or final results from the processing of equations, formulas, operations, and operational logic.

In several embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 1000 can be provided through various input devices as indicated in block 1130. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 1130 have associated respective input processing elements as known in the art. For example, the RF portion can be associated with elements necessary for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the data stream as necessary for presentation on an output device.

Various elements of system 1000 can be provided within an integrated housing, Within the integrated housing, the various elements can be interconnected and transmit data therebetween using suitable connection arrangement, for example, an internal bus 1140 as known in the art, including the 12C bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed to the system 1000, in various embodiments, using a Wi-Fi network such as IEEE 802.11. The Wi-Fi signal of these embodiments is received over the communications channel 1060 and the communications interface 1050 which are adapted for Wi-Fi communications. The communications channel 1060 of these embodiments is typically connected to an access point or router that provides access to outside networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130.

The system 1000 can provide an output signal to various output devices, including a display 1100, speakers 1110, and other peripheral devices 1120. The other peripheral devices 1120 include, in various examples of embodiments, one or more of a stand-alone DVR, a disk player, a stereo system, a lighting system, and other devices that provide a function based on the output of the system 1000. In various embodiments, control signals are communicated between the system 1000 and the display 1100, speakers 1110, or other peripheral devices 1120 using signaling such as AVLink, CEC, or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs. The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

FIG. 11 illustrates the process for an image encoder according to at least one embodiment. The process 1101 is for example implemented by a device 1000 of FIG. 10 and more particularly by a processor 1010 or an encoder 1030 of such device. In step 1111, the processor obtains input data. In step 1112, the processor selects a subset of parameters based on the input data, the subset of parameters being used for fine-tuning a model of a first neural network. In step 1113, the processor determines parameters updates for the selected subset of parameters based on a loss function. In step 1114, the processor packages input data and information representative of the parameters update.

FIG. 12 illustrates the process for an image decoder according to at least one embodiment. The process 1201 is for example implemented by a device 1000 of FIG. 10 and more particularly by a processor 1010 or a decoder 1030 of such device. In step 1211, the processor obtains input data and information representative of the parameters update for a selected subset of parameters. In step 1212, the processor selects a subset of parameters based on the input data, the subset of parameters being used for fine-tuning a model of a first neural network. In step 1213, the processor updates the model of the first neural network-based on parameters update for the selected subset of parameters. In step 1214, the processor determines output data by processing the input data with the updated first neural network.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for encoding an image, wherein a first neural network is used for decoding and a second neural network is used for encoding, the method further comprising:
obtaining the image;
determining an embedding vector by processing the image with the second neural network;
quantizing the embedding vector;
selecting a subset of parameters for fine-tuning a model of a first neural network based on the quantized embedding vector;
determining parameter updates for the selected subset of parameters based on a loss function, wherein the first neural network is updated using parameters updates for the selected subset of parameters; and
packaging the quantized embedding vector and information representative of the parameter updates.

2. The method of claim 1, wherein determining parameters updates is further based on a target output.

3. The method of claim 1, wherein selecting the subset of parameters is based on a gradient of the output of the model to select the parameters having the largest impact.

4. The method of claim 1, wherein the selecting the subset of parameters is based on a loss function using a reference-less metric determined based on the image.

5. The method of claim 1, wherein the parameters are selected among a set comprising a bias of the model, a weight of the model, parameters of a non-linear function of the model, a subset of layers of the model, a specific layer of the model, the bias of a specific layer of the model, and a subset of neurons of the model.

6. (canceled)

7. The method of claim 1, wherein determining parameters updates is further based on the image.

8. (canceled)

9. A method for decoding an image comprising:
obtaining a quantized embedding vector and information representative of an update of a selected subset of parameters;
selecting a subset of parameters for fine-tuning a model of a neural network-based on the-quantized embedding vector;
updating the model of the neural network-based on the update for the selected subset of parameters; and
determining an output image by processing the quantized embedding vector with the updated neural network.

10-11. (canceled)

12. The method according to claim 1, wherein the selection of the subset of parameters is independent from information representative of the parameters update.

13. A device for encoding an image, wherein a first neural network is used for decoding and a second neural network is used for encoding, the device comprising a processor configured to:
obtain the image;
determine an embedding vector by processing the image with the second neural network;
quantize the embedding vector;
select a subset of parameters for fine-tuning a model of a first neural network based on the quantized embedding vector;
determine parameter updates for the selected subset of parameters based on a loss function, wherein the first neural network is updated using parameters updates for the selected subset of parameters; and
package the quantized embedding vector and information representative of the parameter updates.

14. The device of claim 13, wherein determining parameters updates is further based on a target output.

15. The device of claim 13, wherein selecting the subset of parameters is based on a gradient of the output of the model to select the parameters having the largest impact.

16. The device of claim 13, wherein selecting the subset of parameters is based on a loss function using a reference-less metric determined based on the input data.

17. The device of claim 13, wherein the parameters are selected among a set comprising a bias of the model, a weight of the model, parameters of a non-linear function of the model, a subset of layers of the model, a specific layer of the model, the bias of a specific layer of the model, and a subset of neurons of the model.

18. (canceled)

19. The device of claim 17, wherein determining parameters updates is further based on the image.

20. (canceled)

21. A device for decoding an image comprising a processor configured to:
obtain a quantized embedding vector and information representative of an update of a selected subset of parameters;
select a subset of parameters for fine-tuning a model of a neural network-based on the quantized embedding vector;
update the model of the neural network-based on the update for the selected subset of parameters; and
determine an output image by processing the quantized embedding vector with the updated neural network.

22-23. (canceled)

24. The device according to claim 13, wherein the information representative of the parameters update does not comprise information representative of the selection of the subset of parameters.

25. A computer program comprising program code instructions for implementing the method according to claim 1 when executed by a processor.

26. A non-transitory computer readable medium comprising program code instructions for implementing the method according to claim 1 when executed by a processor.

27. A computer program comprising program code instructions for implementing the method according to claim 9 when executed by a processor.

28. A non-transitory computer readable medium comprising program code instructions for implementing the method according to claim 9 when executed by a processor.
